(19) United States
(12) Patent Application Publication
(10) Pub. No.: US 2011/0253520 A1
(43) Pub. Date: Oct. 20, 2011

(54) LIGHT DIFFUSER ACTUATOR FILM (LDAF) KEYPAD MODULE

(76) Inventor: Jit Ming Bryan Lim, Singapore (SG)

(21) Appl. No.: 13/140,045

(22) PCT Filed: Dec. 17, 2008
(86) PCT No.: PCT/SG2008/000487

§ 371 Date: Jun. 16, 2011

(51) Int. Cl. H01H 13/83

(52) U.S. Cl. 200/5 A

(57) ABSTRACT

A keypad module which comprises a light diffuser actuator film (LDAF) and metal dome sub modular assembly for a total keypad solution that can overcome the shortcomings of the prior art, also being slim in thickness, consume less electrical energy as well as being easy to manufacture reducing the amount of involved human resources, consolidating plunger sheet and light guide film into one layer and also capable of providing a good tactile feel and an uniform luminescence on the key top, being properly applicable to telecommunication devices, remote controls, PDAs, car audios and controls etc as shown in FIG. 4.

### FIELD OF THE INVENTION

The current invention relates to a keypad module for mobile phones, and particularly to a keypad module provided with an incorporated Light Diffuser Actuator Film (LDAF).

### TECHNICAL BACKGROUND

A mobile phone is a wireless communication appliance capable of allowing the user to carry and use it. Such appliance may have diverse designs of the hand-phone terminal comprising bartype phones with exposed key buttons, flip-type phones, fold-up type or swinging type compact mobile phones to improve further on the portability and outlook.

In addition, the hand phone includes a keypad assembly as input means for carrying out several wireless communication functions. The keypad is an assembly of individual parts, stacked up together, and has numeric and alphabetical characters and/or symbols, which are depressed or touched by the user.

A normal conventional keypad of the prior art is just an individual piece of key top whereby it has a web to activate the tactile feel and/or have a separate actuator and/or plunger and metal-dome providing the user with a tactile feeling.

The current plunger sheets have either limitation on the keypad height and/or are restricted due to its mechanical properties, which result in too many layers of components and/or difficulty to achieve the web thickness, due to manufacturing process constraints.

Therefore it is impossible to have even click ratio. In addition, the current plunger sheet may not be able to offer good tactile feel, transmit input force from the key-top to the metal dome and to laminate the key top as a single layer.

Also, the keypads of the prior art are not easy to manufacture and/or are not adequate for avoiding the tedious amount of mechanical errors and do not allow a reduction of the human factor, because they are either restricted by manufacturing process constraints.

In addition, the current keypad light up portion is provided by many light emitting diodes (LED) and/or an electroluminiscent (EL) lamp. The LED lighted up keypad view from the user provides inconsistent luminescent, this is due to the placement of the LED which is designated at the specific location near the printed icons on the key top. This created hot spot to icons that is near to the LED, such concept requires many light emitting diodes (LED) to be mounted, resulting to high energy consumption. The other alternative light source, EL Lamp provides uniform luminescent on the key top, but it is costly and/or consuming more energy. Such EL lamp had shorter life spend, the printed dielectric layer, provide the luminescence light, subject to user operating pressure, result to the peeling of dielectric ink layer from the carrier film after a period of time.

Therefore, there is a need to provide a keypad module for mobile phones which overcomes the shortcomings of the prior art, also being slim in thickness, as well as being easy to manufacture reducing the amount of involved human resources, conserve less electrical energy by using less light emitting diodes (LED) for the key top luminescent, and must provide an uniform luminescence light up to key top icon from user's view. The luminescent component must also be robust, able to withstand user's operating pressure, also capable of providing a good tactile feel, and even click ratio, importantly consolidating the light guide and plunger into 1 layer.

For the above purposes, the keypad module of the present invention is disclosed—comprising a Polycarbonate (PC) and/or Polyethylene Therephtalate (PET) film with moulded plunger on one side and/or with a micro dot structure or micro nubs form and/or screen printed on the opposite side and a metal dome sub modular assembly for a total keypad solution that can diversify away from the current keypads and overcome the shortcomings of the prior art. Such a keypad module is claimed in independent claim 1.

### BRIEF DESCRIPTION OF THE DRAWINGS

A detailed description of the invention will now be provided with reference to the accompanying drawings in which:

FIG. 1a shows a front view of a silicone rubber plunger of the prior art;

FIG. 1b shows a cross sectional view of the silicone rubber plunger of FIG. 1a;

FIG. 1c shows an enlarged view of detail A of the plunger of FIG. 1b;

FIG. 2a shows a front view of a silicone rubber key of the prior art with actuator;

FIG. 2b shows a X-X′ cross sectional view of the silicone rubber key with actuator of FIG. 2a;

FIG. 2c shows an enlarged view of detail A of the actuator and/or plunger of FIG. 2ab;

FIG. 3 shows a cross sectional view of a keypad with a normal actuator stack-up;

FIG. 4 shows a cross sectional view of a keypad module of the invention with an inverted light diffuser actuator film (LDAF) stack-up;

FIG. 5 shows a cross sectional view of a keypad module of the invention with a normal light diffuser actuator film (LDAF) stack-up;

FIG. 6a shows an exploded isometric front view of the Light diffuser actuator film (LDAF) and metal dome sub modular assembly;

FIG. 6b shows an exploded isometric back view of the Light diffuser actuator film (LDAF) and metal dome sub modular assembly;

FIG. 7a shows the Actuator side in isometric view;

FIG. 7b shows a Dot Pattern side isometric view;

FIG. 8a shows the Plunger side in detailed 2D view;

FIG. 8b shows the Dot Pattern side in detailed 2D view;

FIG. 9 shows a cross sectional view of the Light diffuser moulded with actuator;

FIG. 10 shows a partial plan view of the Light diffuser moulded with actuator;

FIG. 11 shows an Isometric cross sectional view of the Light diffuser moulded with actuator;

FIG. 12a shows the LED light energy only partially transmitted into the diffuser film due to the thickness of the film;

FIG. 12b shows the LED light energy being fully absorbed into the diffuser film by the absorber.

### DETAILED DESCRIPTION OF THE INVENTION

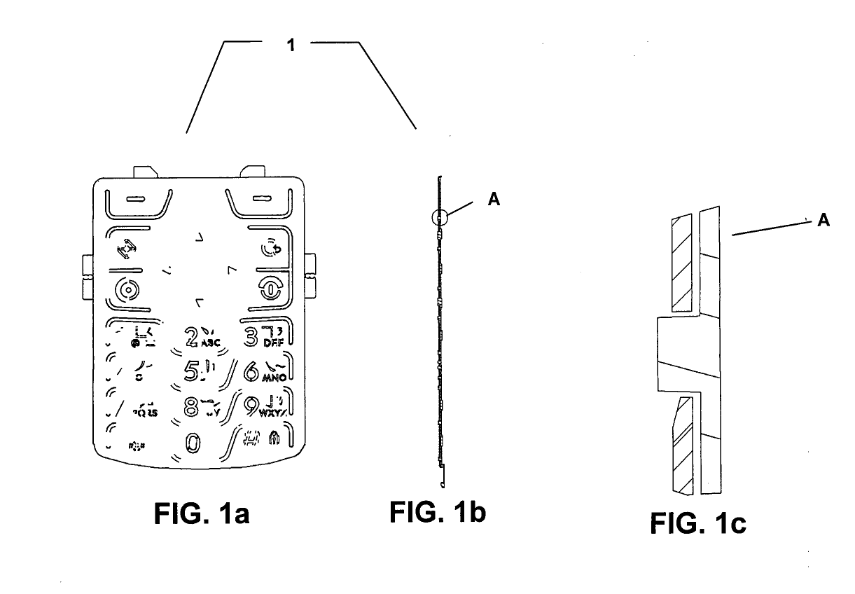

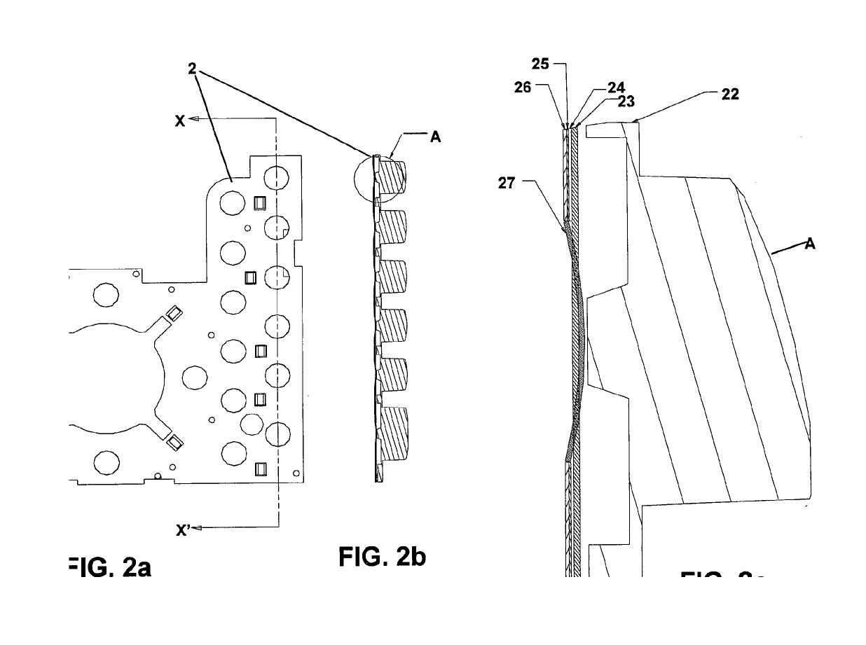

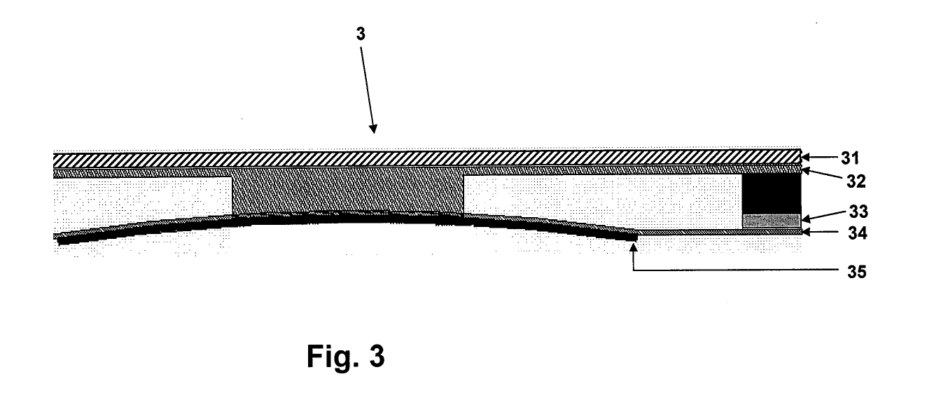

Making a reference to the prior art, FIGS. 1a, 1b and 1c depict a silicone rubber plunger sheet (1) front view, a cross section view and a detail A, respectively. Referring to FIGS. 2a, 2b and 2c, they depict, respectively, a front elevational view, a cross section X-X′ and an enlarged view of detail A of a silicone rubber key with plunger (2), where the different elements forming the silicone rubber key with plunger (2) are shown in detail: a rubber keypad (22), light guide film (LGF) (23), adhesive (24), protective film (25), adhesive film (26) and metal dome (27). This normal conventional keypad is just an individual piece of a key top whereby it has a web to activate the tactile feel and/or have a separate plunger and metal-dome providing the user with a tactile feeling. Regarding to FIG. 3, there are respectively shown a cross section view (3) of the prior art, where the different components of the light guide plunger are represented separately: metal mesh (31), mold-print plungers with island (32), stopper adhesive (33), Mylar dome sheet (34), and metal dome (35).

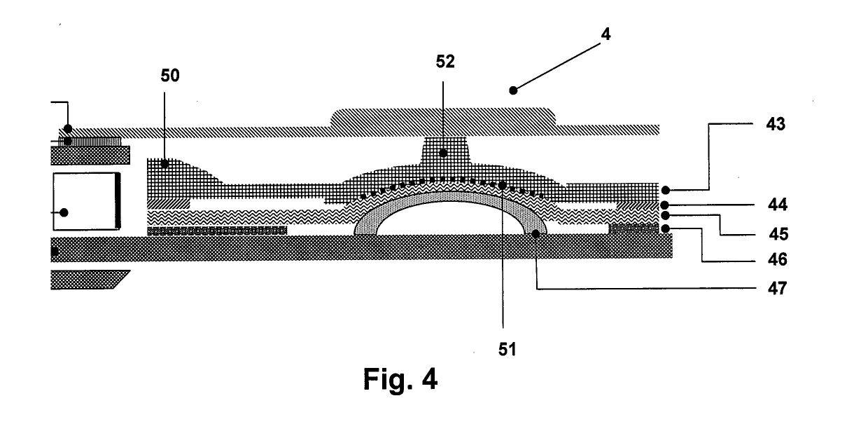

According to the present invention, it is disclosed a preferred embodiment of a keypad module (4) (FIG. 4) for a mobile phone comprising: a key-top layer 1 (41) with second surface printing; a key-top adhesive layer 2 (42) for bonding the key-top (41) to the adjacent layer; an actuator layer moulded to a light guide film (LGF) surface having a plurality of bosses (52) protruded from a position corresponding to movable contacts and a plurality of UltraViolet (UV) polymer or silicone rubber plungers, each disposed on the key top at a position corresponding to each boss (52) and protruding from the LGF at a desired height, the alternate side of the moulded plunger, dot patterns (51) are locally formed in specific regions, so that light is intensively supplied to the predetermined regions of the keypad (LDAF) layer 3 (43) through a light absorber (50); a LDAF adhesive layer 4 (44) to bond the light guide plunger to the adjacent layer; a dome Mylar layer 5 (45) to locate metal domes at predetermined positions corresponding to the plunger on top an ON/OFF circuit printed on a Printed Circuit Board (PCB) and/or Flexible Printed Circuit (FPC); a dome spacer layer 6 (46) for bonding the dome Mylar (45) to the PCB and/or FPC; a metal domes layer 7 (47), having a plurality of movable contacts disposed on a printed circuit board (PCB, see below), each of the key tops being printed with numeric, alphabetical or symbolic displays of the key top to transmit light through the display; a printed circuit board (PCB) and/or flexible printed circuit (FPC) layer 8 (48) having a plurality of stationary contacts; a light emission diode (LED) layer 9 (49) providing the light source to illuminate the key top through the light diffuser actuator film (LDAF) (43). The dot patterns (51) are formed by means of a thermoforming or printing process.

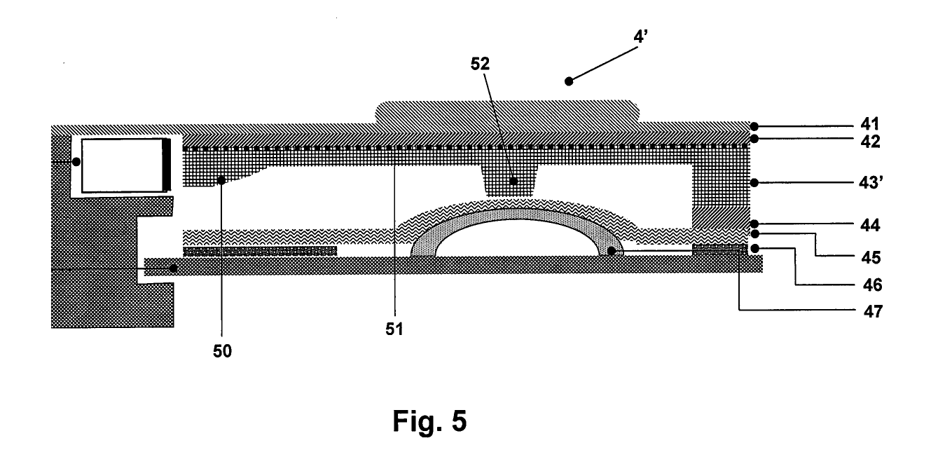

Another aspect to the present invention, (FIG. 5), the light guide film plunger (43′) can be reversed with the micro dot pattern (51) directly under the key top, the plunger (52) directly on top of the metal dome (47).

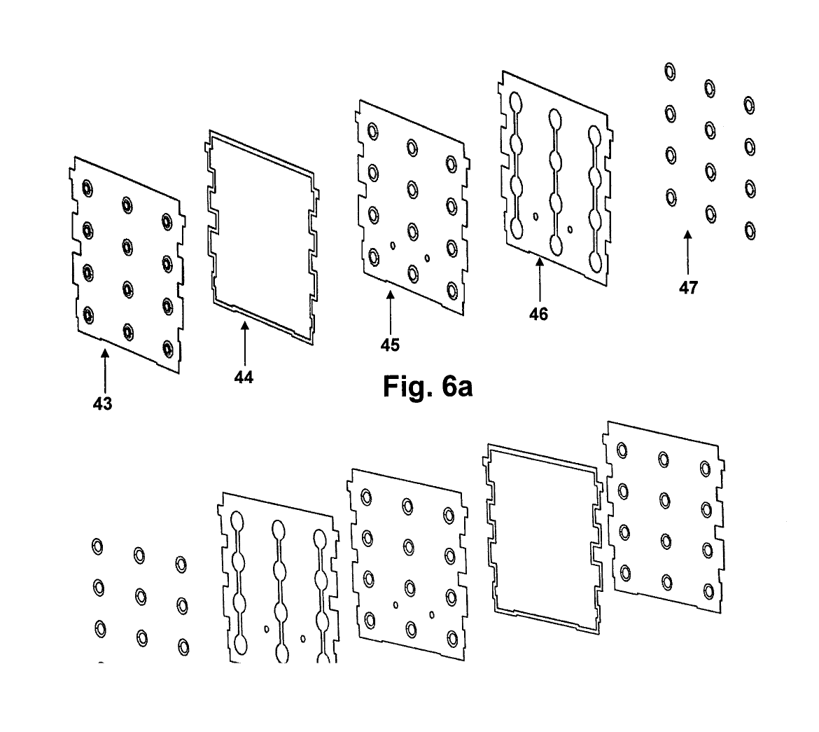

FIG. 6a further clarifies the LDAF (4) concept by showing an exploded isometric view of the preferred embodiment of the invention depicting five layer which constitute the core of the invention: an actuator co-moulded LDAF (43), a LDAF adhesive (44), a dome Mylar (45), a dome pacer (46), and a metal dome (47). It is shown how the cites layer are stacked up from bottom (47) to top (43). FIG. 6b represents a back view of the elements of FIG. 6a.

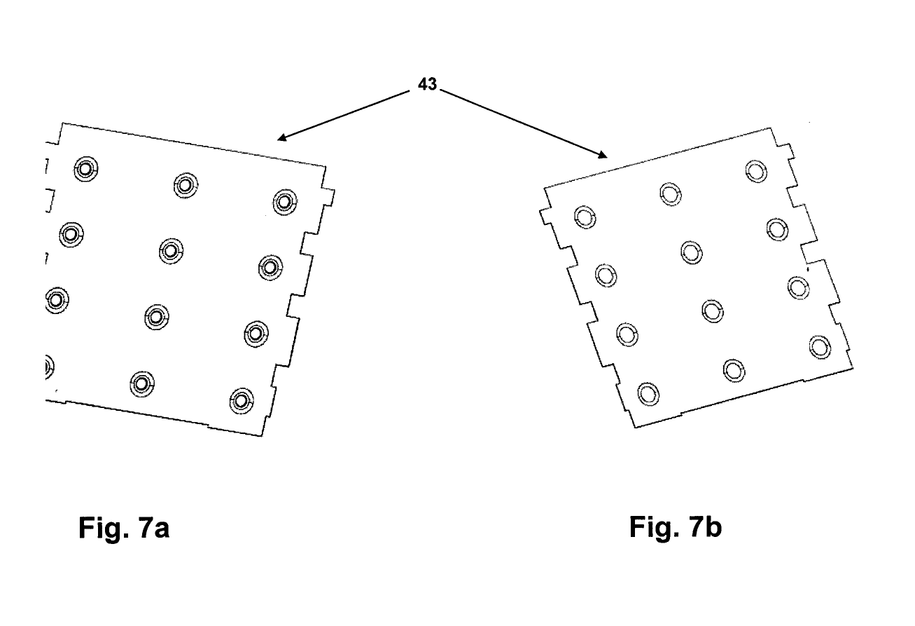

FIGS. 7a and 7b show, respectively, a front and a back isometric view of the Light Diffuser Actuator Film (LDAF) (43), where is depicted the actuator surface at the front view and the dot pattern (51) at the back view.

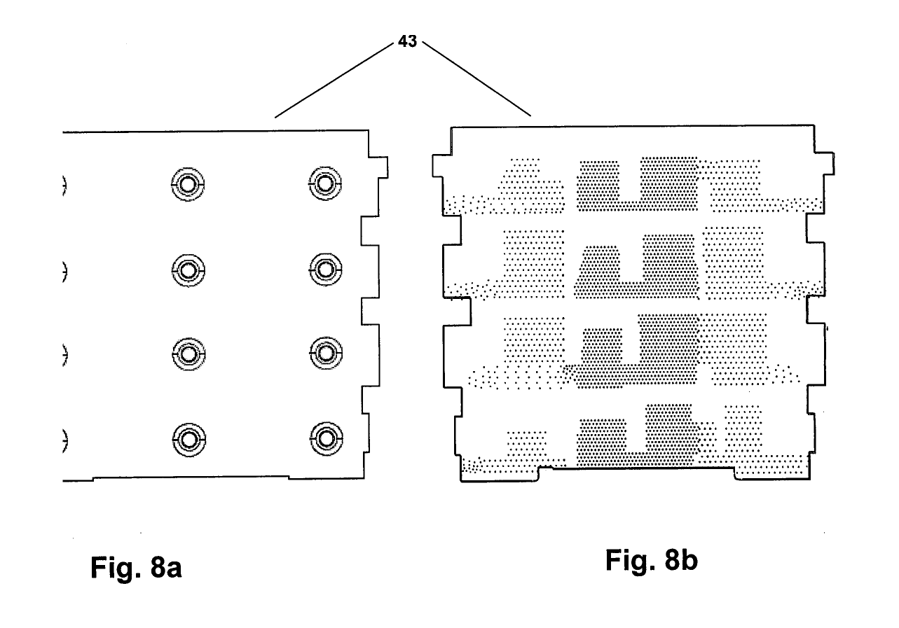

FIGS. 8a and 8b show a 2D detailed view of the Light Diffuser Actuator Film (43) where there is represented, respectively, the plunger at the front view and the dot pattern (51) at the back view.

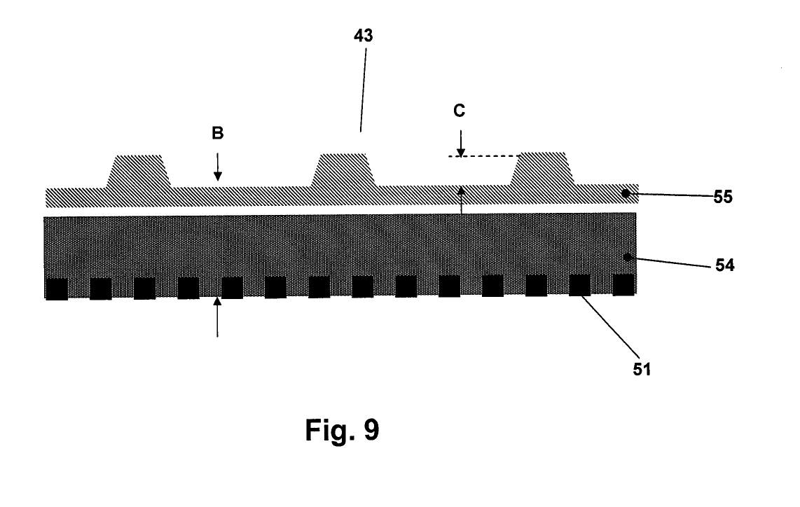

According to further another aspect of the present invention, the light diffuser actuator film (LDAF) (43), (FIG. 9) of the present invention, is the most important layer on the whole module (4); it causes the incident light from the side light source, formed by the light emission diode (LED) layer 9 (49), to be surface emitted by the micro dot pattern structure (51) on the polycarbonate (pc) film, the UV and/or silicone moulded plunger (54) on the alternate side of the micro structure geometry also controls the ergonomic and tactile feel to the user. Additionally, dimensions B and C represent, respectively, the web thickness and the plunger height.

Still another further aspect to the present invention, a light absorber (50) (FIG. 4 & FIG. 5 can be moulded together with the plunger (43) just beside the light emitting diode (49), the light absorber (50), absorbs the maximum amount of light from the light emitting diode (LED) into the light guide film, resulting to a brighter luminescence on the key top.

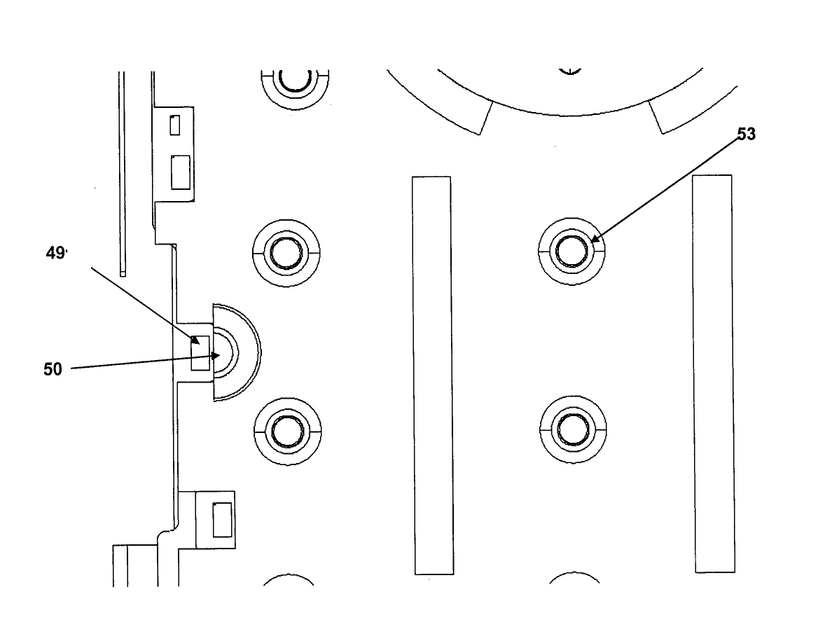

FIG. 10 shows a partial plan view of the Light Diffuser Actuator (4) where is depicted in detail a LED light source (49) and some actuators (53).

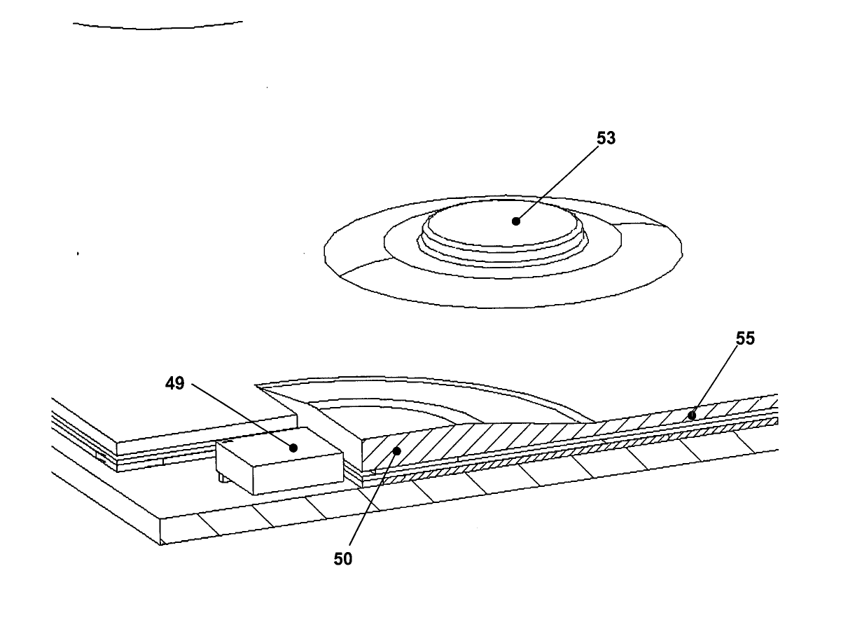

FIG. 11 shows an isometric cross sectional view of the Light Diffuser Actuator (4) where there is represented a LED (49), the light absorber (50), the co-moulded UV layer (55) and one actuator (53).

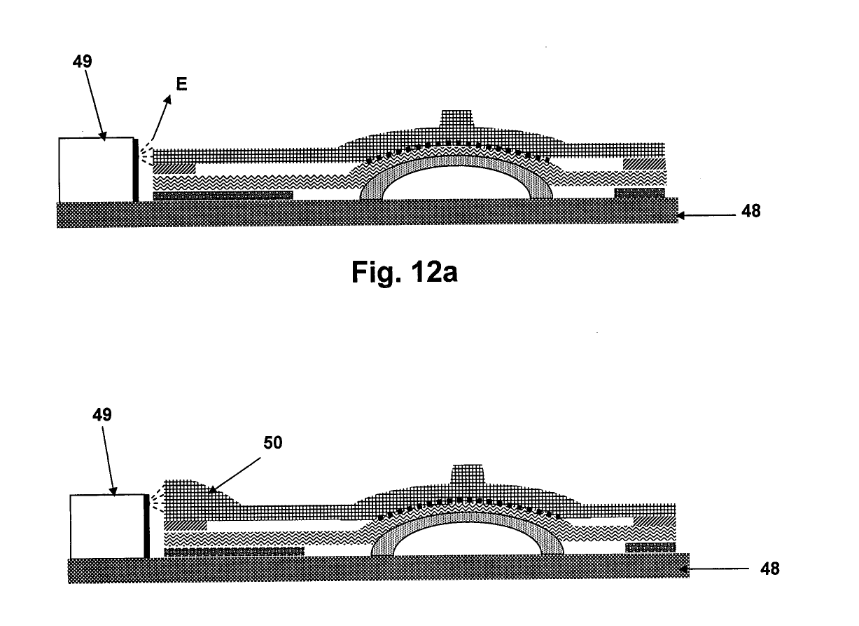

FIGS. 12a and 12b illustrate a comparison between a normal light guide film thickness and the LGF of the invention provided with an absorber (50), where there is shown how the light rays are fully transmitted to the LGF by the absorber (50) in the preferred embodiment of the invention, whereas there is loss of light energy in other embodiments of the prior art.

Having described in detail the present invention, it will be obvious for any skilled in the art that modifications may take place regarding materials and arrangements without departing from the essence of the invention, which is claimed below.

1. A keypad module (4) made up by stacking up the following layers:
a key-top layer 1 (41) with a surface printing;
a key-top adhesive layer 2 (42) for bonding the key-top layer (41) to an adjacent layer;
an actuator layer moulded to a light guide film (LGF) surface forming together a layer 3 (43);
a light guide film adhesive layer 4 (44) to bond the light guide film to an adjacent layer;
a dome Mylar layer 5 (45) to locate a plurality of metal domes (47) at predetermined positions;
a dome spacer layer 6 (46) for bonding the dome layer (45) to an adjacent layer;
a metal dome layer 7 (47) having a plurality of domes, each dome provided of movable contacts;
a printed circuit board layer 8 (48) having a plurality of stationary contacts;
a light emitting diode layer 9 (49) to illuminate the key-top (41) through the light guide film (43);
the keypad module (4) characterized in that said light guide film (43) is provided with a plurality of bosses (53) protruding from a position corresponding to said stationary contacts, a plurality of plungers (54) at a positioning corresponding to each boss (53) and in that the alternate side of said light guide film (43), dot patterns (51) are locally formed in specific areas.

2. A keypad module (4′) according to claim 1, characterized in that the light guide film plunger (43′) is stacked up in reverse position with the dot patterns (51) directly under the key-top layer (41).

3. A keypad module (4) according to claim 1, characterized in that said layer 8 (48) is a Flexible Printed Circuit (FPC) having a plurality of stationary contacts.

4. A keypad module (4) according to claim 1, characterized in that the light diffuser actuator film (43) causes that incident light from the light emitting diode (49) is surface emitted by the dot pattern (51) to the plurality of moulded plungers (54).

5. A keypad module (4) according to claim 1, characterized in that said plurality of moulded plungers (54) provide an ergonomic and tactile feel to a user.

6. A keypad module (4) according to claim 1, characterized in that a light absorber (50) is moulded together with the light guide film (43) just beside the light emitting diode (49).

7. A keypad module (4) according to claim 1, characterized in that said light emitting diode (49) is a side-firing LED.
